(19) United States
(12) Patent Application Publication
(10) Pub. No.: US 2002/0164418 A1
(43) Pub. Date: Nov. 7, 2002

(54) Method for producing superconducting wires and stripes based on the compound MgB2

(76) Inventors: Claus Fischer, Dresden (DE); Wolfgang Hassler, Dresden (DE); Margitta Schubert, Dresden (DE); Hans-Peter Trinks, Dresden (DE); Andreas Gumbel, Mainz (DE)

Correspondence Address: COLLARD & ROE, P.C., 1077 Northern Boulevard, Roslyn, NY, 11576-1696, US

(21) Appl. No.: 10/103,312

(22) Filed: Mar. 21, 2002

(30) Foreign Application Priority Data
Mar. 22, 2001 (DE) 101 14 934.4

(51) Int. Cl. B05D 3/02

(52) U.S. Cl. 427/180; 427/376.1; 505/320

(57) ABSTRACT

A method for creating a long superconducting wire and tape materials that can be loaded with high current densities using MgB₂. The method is based on the powder-in-the-tube technology. In this process, there is a composite consisting of a cover tube made of material with normal conductivity, and a powder of a superconducting compound or a preliminary product. This powder compound contained in this cover tube, are processed by reshaping and thermal treatment steps to the superconducting wire or tape material. According to the invention, a composite is supplied to the processing process that contains a powdery superconducting MgB₂ compound or a powdery preliminary product for a superconducting MgB₂ compound. The powdery preliminary product, has been only partially reacted to an MgB compound, or is a powder mixture consisting of the individual components of the desired MgB₂ compound. This product is filled into the cover tube.

### BACKGROUND OF THE INVENTION

The invention relates to a method for producing superconducting wire and tape material using the compound MgB₂. Such tape and wire materials are especially suited as superconductors for applications in the field of energy technology.

### PRIOR ART

A superconducting line with Tc=39 K to 40 K has recently been demonstrated for the first time in the binary alloy MgB₂ (J. NAGAMATSU, N. NAGAKAWA, T. MURANAKA, Y. ZENITANI and J. AKMITSU, Nature 410 (2001), 63).

Furthermore, an MgB₂ wire has been produced in an experiment by treating a boron wire in a quartz test tube in the presence of Mg-powder with heat, whereby Mg diffuses into the boron wire (CANFIELD ET AL, Superconductivity in Dense MgB₂ Wires, Cond. Nat., publ. Cond-mat Homepage of 02-15-01: cond-mat/0102269). Such a procedure, however, is not suitable for producing technical wires.

It is also possible to produce MgB₂ wires, for example from a compact material that is not readily feasible because MgB₂ is very brittle.

### SUMMARY OF THE INVENTION

The invention is based on the problem of providing a method permitting the technical manufacture of long, superconducting wire and tape or strip material using MgB₂ that can be loaded with high current densities.

This problem is solved by using a method that is based on the “powder-in-the-tube” technology, which is known per se. In this process, a composite consisting of a cover tube made of a material with normal conductivity, and a powder of a superconducting compound, or of a preliminary product of the compound contained in the tube, are processed to the superconducting wire material by reshaping and thermal treatment steps.

A composite is supplied to the processing method that contains a superconducting MgB₂ compound in the form of powder filled in a cover tube, or of a preliminary product in the form of powder for a superconducting MgB₂ compound. The powdery preliminary product is filled into the cover tube as a mechanically alloyed powder that reacts only partially to an MgB₂ compound. The preliminary product can also be in the form of a powder mixture consisting of the individual components of the desired MgB₂ compound.

The composite could include a MgB₂ compound or a preliminary MgB₂ that has additional components such as Al, Ag, Cu, Au, Sc, Y, Dy, Gd, Hf, Ti, Zr, Ta, V, Nb, Cr, Mo, Mn, Os, Ru, C, Si, N and/or O incorporated in its crystal lattice.

In addition, it is also possible to use a single-component powder mixture consisting of only Mg-powder and B-powder.

However, it is possible also to use a single-component powder mixture consisting of Mg-powder and B-powder as well as one or more metal powders of Al, Ag, Cu, Au, Sc, Y, Dy, Gd, Hf, Ti, Zr, Ta, V, Nb, Cr, Mo, Mn, Os and Ru.

The powders should have a narrow grain band with an average particle size of d <10 μm. It is also preferable to use powders that have two narrow grain bands that differ from each other in the average grain size by the factor 5 to 10.

The cover tubes may consist of Cu, Ag, Ta, Nb, Mo, W, Fe or Mg, or their alloys.

When an Mg cover tube is used, it can be surrounded by another cover tube that preferably consists of Fe, Nb or Ta.

One or more treatments should be used to de-solidify the cover tube during the step when the composite is reshaped, and the step for forming the superconducting MgB₂ compound from the preliminary MgB₂ product. This step also includes the step of sintering the superconducting MgB₂ compound in the compacted composite. These heat treatments could be carried out according to the invention at temperatures from 300° C. to 1100° C., in an inert gas at a low oxygen partial pressure or with small amounts of additions such as H.

For example, the thermal treatment for de-solidifying the cover tube occurs at temperatures between 300° C. and 1100° C.

The thermal treatment for forming the superconducting MgB₂ compound is carried out at temperatures between 300° C. and 700° C. This treatment treats a preliminary product in the form of powder consisting of a powder mixture of the individual components of the desired MgB₂ compound.

Furthermore, the sintering of the superconducting MgB₂ compound in the compacted composite is carried out at temperatures between 500° C. and 1000° C.

To compact the composite, it is possible also to apply the hot isostatic pressing method (HIP process) at temperatures of >500° C. and pressures of >2 bar.

With the method as defined by the invention it is possible to produce superconducting tape and wire material based on the compound MgB₂ on the large technical scale that are especially suited as superconductors for applications in the field of energy technology.

### DETAILED DESCRIPTION

The method as defined by the invention is explained in greater detail in the following examples of different executions of the method according to the invention.

### EXAMPLE 1

MgB₂ powder with a purity of 98% was pressed cold-isostatically at a pressure of 240 Mpa to form a round rod with a diameter of 8 mm. The rod was placed in a tantalum tube that was sealed at one end and had an inside diameter 10 mm and a wall thickness of 1 mm. The MgB₂ -rod surrounded by the tantalum tube was inserted in a copper tube that was sealed at one end and had an inside diameter of 11 mm and a wall thickness of 1 mm. The open end of this copper tube was subsequently sealed under vacuum as well. The resulting body produced was then reshaped via hammering, grooved rolling and flat rolling into a Cu/Ta/MgB tape material with a thickness of 0.45 mm and a width of 5.7 mm. This tape was then subjected to a one-hour heat treatment at 900° C. in an Ar-atmosphere. A critical temperature of 33 K and critical current densities of 5.1 kA/cm² at 4.2 K in an external magnetic field, and of 1.5 T and 20 kA/cm² at 4.2 K in the own field were measured on specimens of this tape material.

### EXAMPLE 2

To produce a mechanically alloyed Mg—B—powder, an Mg-powder with a purity of 99.8% and an amorphous boron powder with a purity of 99.9% were mixed at the ratio of the stoichiometric composition of the MgB₂, and ground for 20 hours in the purest of Ar-atmospheres in a grinding vessel made of tungsten carbide (WC), using WC-balls as grinding bodies in a planetary ball mill. A Cu/Ta/MgB₂ tape was produced from the powder following in the manner described in example 1. The tape was subjected to a 20-minute heat treatment at 700° C. in an Ar-atmosphere. A critical temperature of 34 K and a critical current density of 25 kA/cm² at 4.2 K in the own field were measured on specimens of this tape material.

What is claimed is:

1. A method for producing superconducting wire and tape materials via a powder in tube technology” comprising the steps of:
providing a cover tube having normal conductivity;
inserting a powder of superconducting compound including an MgB₂ compound into said cover tube; reshaping said cover tube and said powder of superconducting compound; and
heating said cover tube and said superconducting compound in said tube.

2. The method as in claim 1, wherein said step of inserting said powder of superconducting compound includes inserting completely reacted MgB₂ compound having an additional component selected from the group consisting of: Al, Ag, Cu, Au, Sc, Y, Dy, Gd, Hf, Ti, Zr, Ta, V, Nb, Cr, Mo, Mn, Os, Ru, C, Si, N, or O incorporated into its crystal lattice.

3. The method as in claim 1, wherein said step of inserting a powder of superconducting compound includes inserting a single component powder mixture consisting of Mg powder and B powder.

4. The method as in claim 1, wherein said step of inserting said powder of superconducting compound comprises the step of inserting Mg powder and B powder and a component selected from the group consisting of: Al, Ag, Cu, Au, Sc, Y, Dy, Gd, Hf, Ti, Zr, Ta, V, Nb, Cr, Mo, Mn, Os and Ru.

5. The method as in claim 1, wherein said step of inserting said powder of superconducting compound includes steps of inserting a powder having a grain band with an average particle size of d <10 μm.

6. The method as in claim 1, wherein the step of inserting a powder of superconducting compound includes inserting a powder having grain bands of at least two different sizes wherein the sizes differ by a size of a factor of at least 5.

7. The method as in claim 1, wherein said step of providing a cover tube comprises the step of providing a cover tube having a component selected from the group consisting of: Cu, Ag, Ta, Nb, Mo, W, Fe or Mg.

8. The method as in claim 1, wherein the step of providing a cover tube comprises providing a cover tube having Mg and another component selected from the group consisting of Fe, Nb or Ta.

9. The method as in claim 1, further comprising the steps of:
de-solidifying said cover tube by reshaping a composite material comprising said cover tube and said powder of MgB2;
forming said superconducting MgB₂ compound from a preliminary MgB₂ product; and
sintering said superconducting MgB₂ compound;
wherein these three steps are performed using at least one heat treatment during which said cover tube and said compound are heated at a temperature between 300° C. and 1100° C. in an inert gas at a low oxygen partial pressure or with low amounts of reducing additions.

10. The method as in claim 9, wherein said step of de-solidifying said cover tube occurs during at least one heat treatment at a temperature between 300° C. and 1100° C.

11. The method and powder as in claim 9, wherein said step of forming said superconducting MgB2 compound from a powdery product includes heating said cover tube and said powder in a temperature range between 300° C. and 700° C.

12. The method according to claim 9, wherein said step of forming said superconducting MgB₂ compound from a powdery preliminary product includes heat treating said cover tube and said powder between temperatures of 400° C. and 1000° C.

13. The method as in claim 9, wherein said step of sintering said superconducting MgB₂ compound includes sintering said superconducting compound at a temperature within a range of 500° C. and 1000° C.

14. The method as in claim 9, further comprising the step of compacting said composite by using a HP process at temperatures of at least 500° C. and at a pressure of at least 2 bar during the step of heat treating.

15. The method as in claim 9, wherein said reducing additions comprise H₂.
